(19) United States
(12) Patent Application Publication
(10) Pub. No.: US 2015/0183113 A1
(43) Pub. Date: Jul. 2, 2015

(54) ROBOT, ROBOT CONTROL METHOD AND ROBOT CONTROL PROGRAM

(71) Applicant: JANOME SEWING MACHINE CO., LTD., Tokyo (JP)

(72) Inventor: Kiyoshi WAKAIZUMI, Tokyo (JP)

(21) Appl. No.: 14/559,285

(22) Filed: Dec. 3, 2014

(30) Foreign Application Priority Data
Dec. 27, 2013 (JP) 2013-273420

(51) Int. Cl. B25J 11/00; B25J 9/16; B05B 12/00; B05B 15/10; B05D 1/02

(52) U.S. Cl. CPC B25J 11/0075; B05B 15/10; B05D 1/02; B05B 12/00; B25J 9/1656; Y10S 901/43

(57) ABSTRACT

A robot is connected with an applying device including a reserve tank that reserves an applying material, and an applicator unit that applies the applying material to an applying object, and supplying the applying material from the reserve tank to the applicator by power of a motor. The robot includes a holder moving the applicator unit relative to the applying object, a supply-amount adjuster adjusting a supply amount of the applying material by the applying device, and a moving-speed setter setting a moving speed of the holder. The supply-amount adjuster includes a pulse rate calculator calculating an instruction pulse rate to the motor.

### CROSS-REFERENCE TO RELATED APPLICATION

This application is based upon and claims the benefit of priority from Japan Patent Application No. 2013-273420, filed on Dec. 27, 2013, the entire contents of which are incorporated herein by reference.

### FIELD OF THE INVENTION

The present invention relates to a robot connected to an applying device which applies an applying material to an applying object, a robot control method, and a robot control program.

### BACKGROUND

A desktop type robot connected with an applying device, such as a dispenser or a spray nozzle, for example has been proposed as a device which applies an applying material such as, for example, liquid or powder to an applying object like a substrate. An applying material is supplied, by controlling a stepping motor, etc., from a reserve tank reserving the applying material to the applicator unit such as a nozzle of the applying device The robot includes a holder holding the applicator unit of the applying device, and applies the applying material supplied from the reserve tank to the applying object while moving the applicator unit.

In such robots, some robots are connected with a soldering device or an adhesive applying device as the applying device. When, for example, a soldering device is connected to a robot, the robot holds and moves a tip that is the applicator unit of the soldering device. At this time, by controlling a stepping motor, solder reserved in a reserve tank is supplied to the tip. The robot executes a soldering work while moving the tip, and applies an appropriate amount of solder to the applying object.

Patent Document 1: JP 2002-066965 A

Meanwhile, in applying technologies, finish of an applying object to which an applying material is applied is important. The finish of the applying object becomes excellent when a supply amount of the applying material is maintained at constant amount per a predetermined unit length. Hence, when a moving speed of a holder of the robot changes, it is necessary to appropriately adjust the supply amount of the applying material from the applying device. The change points of the moving speed for the holder of the robot include an application start point and an application end point. The holder of the robot is controlled so as to be gradually accelerated after the start of movement, and gradually decelerated as approaching to the end point.

When the applying material is applied to a corner portion of the applying object, it is difficult to turn the corner unless changing the moving speed of the holder of the robot. Hence, when, for example, a trajectory of the holder moving toward the vertex of the corner is set as an X-axis trajectory, and a trajectory orthogonal to the X-axis trajectory where the holder moves after reaching the vertex of the corner is set as a Y-axis trajectory, the following control is performed. That is, in the X-axis trajectory, the moving speed is gradually decelerated, and after the holder reaches the vertex of the corner, the moving speed is gradually increased in the Y-axis trajectory and is returned to the speed before the holder enters the corner. By performing the control which changes the moving speed as described above, a target trajectory can be realized.

In this case, the supply amount of the applying material in the applying device connected to the robot is controlled through a controller of the applying device. That is, the applying device is controlled independently from the control on the robot. In order to keep the supply amount of the applying material per a unit length constant, it is necessary to synchronize the supply amount by the applying device with a change in the moving speed of the holder of the robot, however a setting work is bothersome, and the synchronization of the moving speed and the supply amount is not practical.

Hence, according to conventional technologies, a structure in which the moving speed of the holder of the robot is changed while maintaining a constant supply amount by the applying device is employed. Therefore, at a portion where the speed of the holder is decelerated and a portion where the holder temporarily stops, the supply amount of the applying material increases, and thus the applying material being applied becomes too thick or a spot clumping of the applying material is formed. Accordingly, a change in the moving speed is minimized by gradually decelerating the moving speed in the X-axis trajectory and gradually accelerating the moving speed in the Y-axis trajectory. In this case, however, the holder is moved so as to draw a circular trajectory, and thus a target trajectory cannot be precisely realized. In addition, even if the spot clumping of the applying material is suppressed, the applied applying material becomes too thick, resulting in a problem of the quality of the applying object.

The present disclosure has been made to address the above-explained problems of the conventional technologies, and it is an objective of the present disclosure to provide a robot, a robot control method, and a robot control program which can precisely realize a target trajectory, and which can suppress an occurrence of a spot clumping of an applying material.

### SUMMARY OF THE INVENTION

To accomplish the above objective, a robot is connected with an applying device comprising a reserve tank that reserves an applying material, and an applicator unit that applies the applying material to an apply target object, and supplies the applying material from the reserve tank to the applicator unit by power of a motor, and, the robot includes: a holder moving the applicator unit relative to the apply target object; a supply-amount adjuster adjusting a supply amount of the applying material by the applying device; and a moving-speed setter setting a moving speed of the holder, in which the supply-amount adjuster includes a pulse rate calculator calculating an instruction pulse rate to the motor.

The pulse rate calculator may calculate the instruction pulse rate to the motor based on the moving speed of the holder, a supply amount of the applying material by the motor per a pulse, and a supply amount of the applying material per a unit work length set in advance.

The moving speed setter may change the moving speed of the holder in accordance with a trajectory, and the pulse rate calculator may sequentially calculate the instruction pulse rate to the motor based on the changing moving speed. The applying device may be a solder supplying device or a bond applying device.

The present disclosure can be in the forms of a method for realizing the functions of the above-explained respective components through a computer or an electronic circuit, and a program that causes a computer to execute the above-explained functions.

According to the present invention, it becomes possible to provide a robot, a robot control method, and a robot control program which precisely realize a target trajectory, and which can suppress an occurrence of a spot clumping of the applying material.

### BRIEF DESCRIPTION OF THE DRAWINGS

FIG. 1 is an explanatory diagram illustrating an example general structure of a robot according to a first embodiment;

FIG. 2 is a functional block diagram illustrating an example control device of the robot of the first embodiment;

FIG. 3 is a functional block diagram illustrating example moving-speed determiner and supply-amount adjuster;

FIGS. 4A to 4C are diagrams illustrating an example application by a conventional robot, and FIG. 4A illustrates a trajectory through which an applicator unit passes on an applying object, FIG. 4B illustrates a graph indicating a moving speed in X and Y axis directions, and FIG. 4C illustrates how an applying material is applied;

FIGS. 5A to 5C are diagrams illustrating an example application by a conventional robot, and FIG. 5A illustrates a trajectory through which an applicator unit passes on an applying object, FIG. 5B is a graph indicating a moving speed in X and Y axis directions, and FIG. 5C illustrates how an applying material is applied;

FIGS. 6A to 6C are diagrams illustrating an example application by the robot of the first embodiment, and FIG. 6A illustrates a trajectory through which an applicator unit passes on an applying object, FIG. 6B is a graph indicating a moving speed in X and Y axis directions, and FIG. 6C illustrates how an applying material is applied; and

FIGS. 7A and 7B are explanatory diagrams illustrating an example applying device.

### DETAILED DESCRIPTION OF THE EMBODIMENTS

### 1. First Embodiment

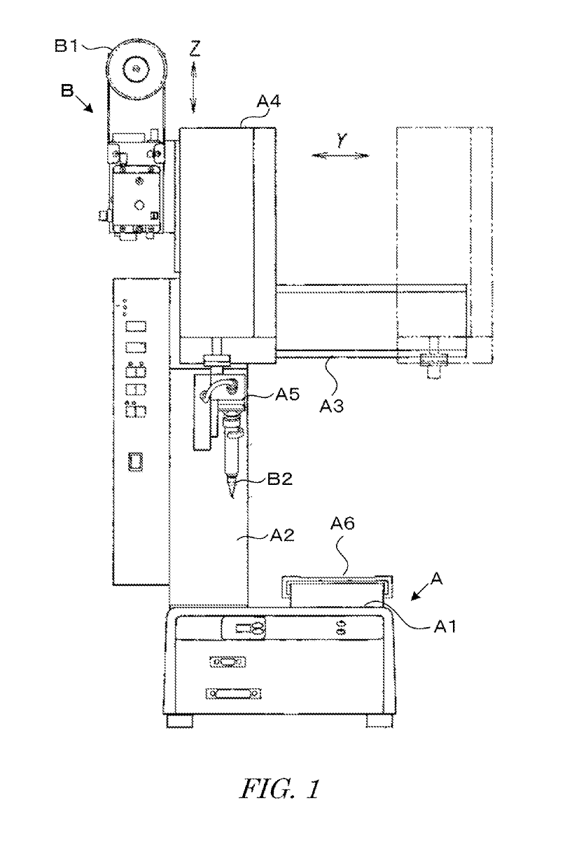

An embodiment of the present invention will be explained with reference to the accompanying drawings. In the following explanation, a robot will be explained as a desktop type robot, but the present invention is applicable to the structures of various robots, such as an orthogonal type, a horizontal multiple-joint type, and a vertical multiple-joint type. In addition, as an applying device connected to the robot, for example, a solder supplying device or an adhesive applying device, that applies liquid or powder applying material, can be used. FIG. 1 illustrates, as an example of this embodiment, a desktop type robot A connected with a solder supplying device that is the applying device.

(1) Applying Device

First, an explanation will be given of an applying device B connected to the robot A. When the applying device B is a solder supplying device, the applying device B includes a reserve tank B1 reserving a string of solder that is an applying material, and an applicator unit B2 that applies the solder to an applying object. The applying device B supplies the string of solder from the reserve tank B1 to the applicator unit B2 based on power of a supplying motor like an unillustrated stepping motor. Hence, in accordance with the structure of the applying device B to be utilized, an amount of solder supplied by the supplying motor driven by a signal per a pulse is set in advance. An example applicator unit B2 is a soldering iron or a laser heater.

(2) Robot

The robot A connected to the applying device B includes a work table A1, a support pole A2, a horizontal arm A3, a Y-axis-direction moving unit A4, a holder A5, and a slide table A6. The work table A1 is a table having an upper face formed as a substantially rectangular plane, and supporting an applying object. In the following explanation, the side of the work table A1 is defined as a lower side, and the vertical relationship will be explained. The work table A1 is provided with the upstanding support pole A2 in a square pillar shape. The horizontal arm A3 extending in a direction orthogonal to the support pole A2 is provided above the support pole A2.

The horizontal arm A3 is provided with the Y-axis-direction moving unit A4 movable in the Y-axis direction that is the horizontal direction. The Y-axis-direction moving unit A4 moves the horizontal arm A3 in the Y-axis direction by drive force of a Y-axis-direction moving motor that is an unillustrated pulse motor. In FIG. 1, the Y-axis-direction moving unit A4 after having been moved is indicated by two-dot chain lines. The holder A5 is provided below the Y-axis-direction moving unit A4.

The holder A5 is a structure which holds the applicator unit B2 of the applying device B. The holder A5 moves in the Y-axis direction together with the Y-axis-direction moving unit A4. In addition, the holder A5 is provided with an unillustrated Z-axis-direction moving motor, thus movable in the Z-axis direction that is the vertical direction. According to the above-explained structure, the holder A5 moves the applicator unit B2 relative to the applying object. In addition, a θ-axis moving unit that rotates the applicator unit B2 may be further provided.

A slide table A6 on which the applying object is mounted is provided on the upper face of the work table A1. The slide table A6 is movable in the X-axis direction on the work table A1 by drive force of an X-axis-direction moving motor that is an unillustrated pulse motor, and moves, in the X-axis direction, the applying object mounted on the upper face. That is, the slide table A6 forms a part of a holder that moves the applicator unit B2 relative to the applying object.

(3) Robot Control Device

The robot A employing the above-explained structure includes a control device illustrated in the functional block diagram of FIG. 2. This control device includes a controller 11, a robot-control-program memory 12, an operating block 13, a display 14, a temporal memory 15, a point-sequence memory 16, a work-instruction-sequence memory 17, a moving-speed determiner 18, and a supply-amount adjuster 19. In this embodiment, the robot A is controlled through a CP control. That is, multiple points continuously compensating spaces between defined spots are provided on a trajectory, and the applicator unit B2 is controlled so as to move in a direction linearly interconnecting the individual points.

The controller 11 is a CPU mainly including a microcomputer, and controls the robot entirely. The robot-control-program memory 12 is a processing unit that stores a control program to control the robot A. The controller 11 executes an input operation, a display, a storing, a motor drive, and a signal input/output in accordance with the control program stored in the robot-control-program memory 12.

The operating unit 13 includes an input device like a keyboard, and hardware and software resources for teaching, and inputs a program of the robot and data thereof. The operating block 13 is also a device which allows an operator to input a change in a set value, such as the moving speed of the holder of the robot A, and the supply amount of the applying material by the applying device B. The display 14 is, for example, an LCD display device, and displays the set value and the input status of the operating block 13.

The temporal memory 15 is a so-called memory, and temporarily stores information which is necessary when the controller 11 outputs a control instruction. The point-sequence memory 16 stores a point where the applying object is moved, and a work executed at this point. The point-sequence memory 16 stores the point where the robot executes a work as X, Y, and Z coordinates.

The work-instruction-sequence memory 17 stores, as a point-work number, a number indicating work instruction to be executed by the applicator unit B2 held by the holder A5. The work instruction is to instruct the robot to execute a work, and includes various work instructions, such as an applying work and a soldering work. As to the work instruction, work instructions to be executed at multiple timings, such as before the applicator unit B2 moves to a point, while the applicator unit B2 is moving to a point, and after the applicator unit B2 reaches a point, are set and stored. In addition, the work instruction may be stored in association with a number.

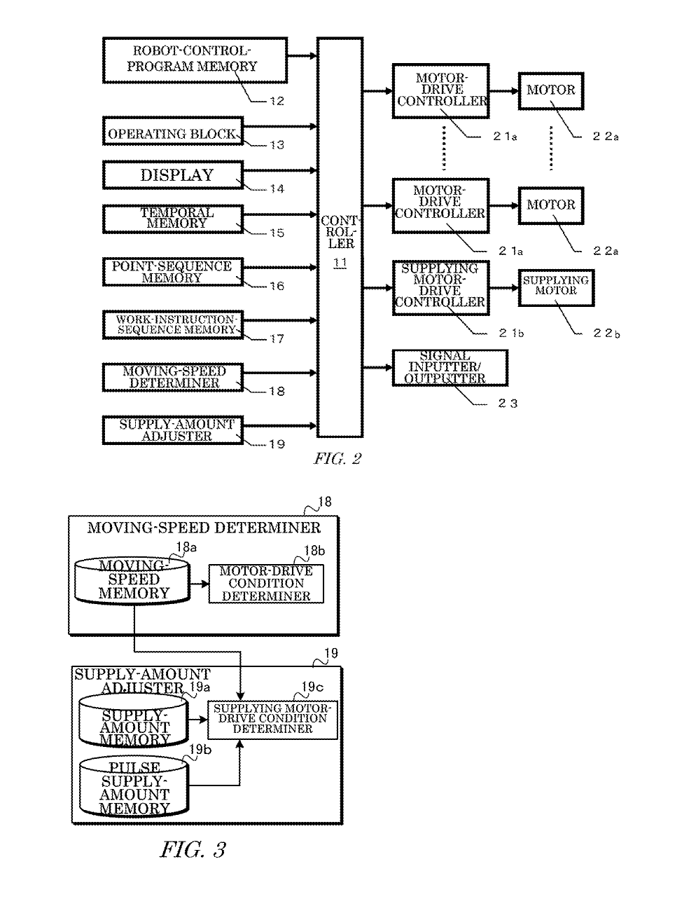

The moving-speed determiner 18 is a processing unit that sets the moving speed of the holder, and as illustrated in FIG. 3, includes a moving-speed memory 18a and a motor-drive condition determiner 18b. The moving-speed memory 18a stores the moving speed of the holder which moves the applicator unit B2 relative to the applying object between points. The moving speed may be a fixed value throughout the entire trajectory, or may be set so as to be changed between points. In the case of a trajectory that can be passed through at a constant speed, a fixed value is preferable. Conversely, in the case of a complex trajectory including a corner portion, etc., it is preferable to change the moving speed in accordance with the trajectory.

The moving-speed memory 18a may store the moving speed in association with an interval that is a space between points. Each point can be expressed in X and Y coordinates. The moving speed may be stored in advance or the moving speed which is input through the operating block 13 may be stored. The moving-speed memory 18a outputs the moving speed between points to the motor-drive condition determiner 18b and a supplying motor-drive condition determiner 19c to be discussed later.

The motor-drive condition determiner 18b is a processing unit that determines the motor drive quantity to obtain a desired moving speed based on a signal from the moving-speed memory 18a. The motor-drive condition determined by the motor-drive condition determiner 18b is output to a motor-drive controller 21a to be discussed later through the controller 11.

The supply-amount adjuster 19 is a processing unit that adjusts the supply amount of the applying material by the applying device B, and as illustrated in FIG. 3, includes a supply-amount memory 19a, a pulse supply-amount memory 19b, and the supplying motor-drive condition determiner 19c. The supply-amount memory 19a stores the supply amount of the applying material per a unit work length. The supply amount of the applying material per a unit work length is a value set by the operator. For example, like 2 μL/mm, it is an amount of the applying material applied with respect to a given length. The supply amount of the applying material per a unit work length may be stored in advance or the supply amount which is input through the operating block 13 may be stored.

The pulse supply-amount memory 19b is a memory that stores the amount of applying material supplied by a supplying motor 22b driven by a signal per a pulse. This value is determined in accordance with the structure of the applying device B, and may be stored in advance, or the value input through the operating block 13 may be stored. The supply-amount memory 19a and the pulse supply-amount memory 19b output the storing supply amounts to the supplying motor-drive condition determiner 19c.

The supplying motor-drive condition determiner 19c (pulse-rate computing block) is a processing unit that calculates an instruction pulse rate to the supplying motor 22b. In this embodiment, the supplying motor-drive condition determiner 19c calculates an instruction pulse rate to the supplying motor 22b based on the input moving speed of the holder, the supply amount of the applying material by the supplying motor 22b per a pulse, and a supply amount of the applying material per a unit work length. More specifically, the supplying motor-drive condition determiner 19c calculates the number of pulses in a second as a pulse rate through the following formula 1.

[Formula 1]

Instruction Value C=A×V÷B

where:

V is the moving speed of the holder (e.g., mm/s unit);

A is a supply amount of the applying material per a unit work length (e.g., mm/pls unit); and

B is a supply amount of the applying material by the supplying motor per a pulse (e.g., mm/m unit).

The pulse rate determined by the supplying motor-drive condition determiner 19c is output to, as a drive condition of the supplying motor 22b, a supplying motor-drive controller 21b to be discussed later through the controller 11.

The controller 11 is connected with the motor-drive controller 21a, the supplying motor-drive controller 21b, and a signal inputter/outputter 23. The controller 11 outputs instructions to the motor-drive controllers 21a, 21b to drive the motor 22a and the supplying motor 22b, thereby executing various operations. The motor-drive controller 21a is a processing unit that controls the motor 22a based on the drive condition determined by the motor-drive condition determiner 18a. The motor 22a is a drive unit which moves the connected applicator unit B2 relative to the applying object by the power of the motor 22a, and causes the applicator unit B2 to execute a work and an operation.

Multiple motor-drive controllers 21a and motors 22a may be provided as needed. When, for example, the above-explained applying device B is utilized, in addition to an X-axis-direction moving motor, a Y-axis-direction moving motor, and Z-axis-direction moving motor to move the applicator unit B2 to a predetermined point, and a θ-axis-direction moving motor to rotate the applicator unit B2 may be provided so that a control is performed by a total of four motors.

The supplying motor-drive controller 21b is a processing unit that controls the supplying motor 22b based on the drive condition determined by the motor-drive condition determiner 19b. The supplying motor 22b is a drive unit that supplies, by its power, the applying material from the reserve tank B1 to the applicator unit B2. The signal inputter/outputter 23 is a processing unit that inputs a signal from the exterior or outputs a signal thereto based on an instruction from the controller 11. The signal inputter/outputter 23 has functions of reflecting the external input signal on a control to the robot, and outputting a control signal, etc., to an external device.

[1.2 Operation]

An example operation of the above-explained robot A will be explained in comparison with conventional examples.

### (1) First Conventional Example

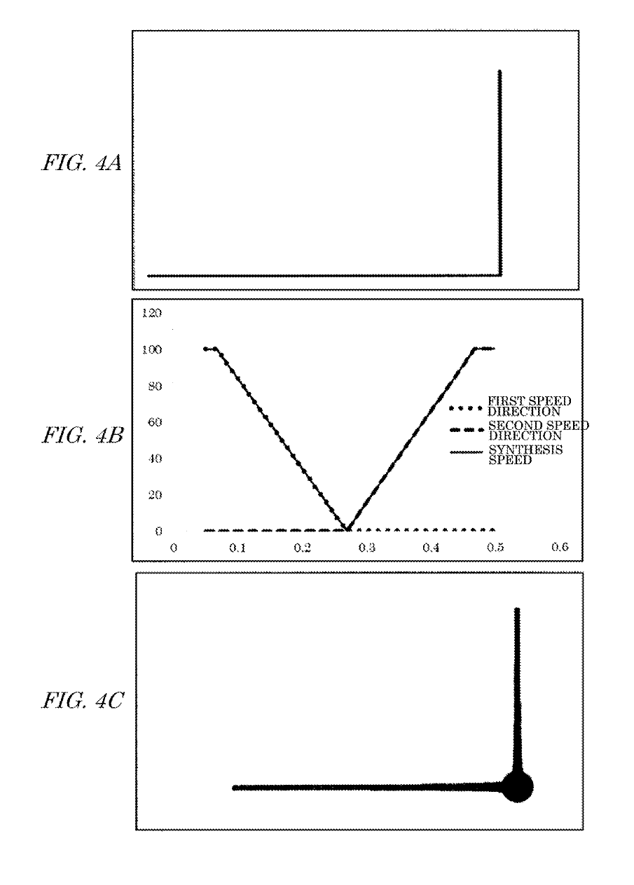

As a first conventional example, FIGS. 4A to 4C illustrate an example application by a robot that changes the moving speed of the holder thereof while maintaining a constant supply amount by the applying device giving a preference to a trajectory. FIG. 4A illustrates a trajectory through which the applicator unit B2 passes on an applying object, FIG. 4B is a graph indicating a moving speed in the X and Y axis directions, and FIG. 4C illustrates how the applying material is applied.

As illustrated in FIG. 4A, the applicator unit B2 has the holder controlled so as to follow a trajectory turning at right angle along the corner portion of the applying object. In this case, the moving-speed memory 18a stores a moving speed indicated in the graph of FIG. 4B. That is, for example, the moving speed in the X-axis trajectory (first speed direction in the figure) is gradually decelerated, and after the applicator unit B2 reaches the vertex of the corner, the moving speed in the Y-axis trajectory (second speed direction in the figure) is gradually accelerated. According to this method, the applicator unit B2 is not moved simultaneously in both of the X-axis direction and the Y-axis direction, and thus a target trajectory can be precisely realized.

According to the above-explained trajectory and moving speed, when the supply amount of the applying material is set to be constant, the applying material is applied as illustrated in FIG. 4C. That is, at a portion where the moving speed of the applicator unit B2 is decelerated, the supply amount of the applying material increases, and the applying material becomes thick. In addition, at the vertex of the corner where the relative movement of the applicator unit B2 is temporarily suspended, a spot clumping is caused. It is not illustrated in the figure but the applied applying material becomes thick at the start point of the application and the end point thereof because the applicator unit B2 is decelerated. Therefore, even if the trajectory can be precisely traced, there is a problem in the quality of the applying object.

### (2) Second Conventional Example

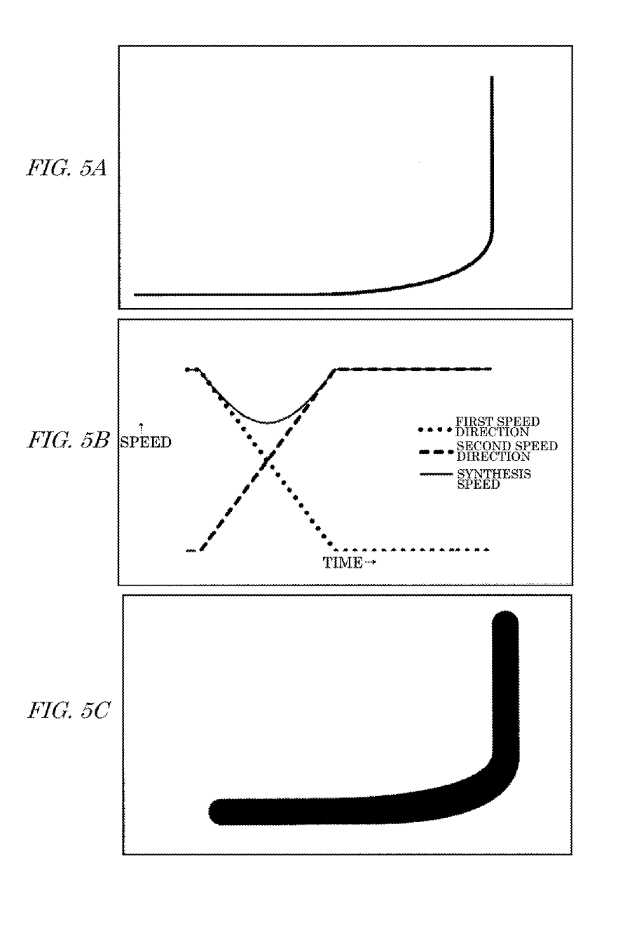

As a second conventional example, FIGS. 5A to 5C illustrate an example application by a robot that changes the moving speed of the holder thereof while maintaining a constant supply amount by the applying device giving a preference to the speed. FIG. 5A illustrates a trajectory through which the applicator unit B2 passes on an apply target object, FIG. 5B is a graph indicating a moving speed in the X and Y axis directions, and FIG. 5C illustrates how the applying material is applied.

As illustrated in FIG. 5A, according to the second conventional example giving a preference to the speed, the applicator unit B2 has the holder controlled so as to follow, for example, a circular arc trajectory for turning the corner portion of the applying object. In this case, the moving-speed memory 18a stores a moving speed indicated in the graph of FIG. 5B. That is, for example, the moving speed in the X-axis trajectory (first speed direction in the figure) is gradually decelerated, and the moving speed in the Y-axis trajectory (second speed direction in the figure) is gradually accelerated. According to this method, the applicator unit B2 is moved in both of the X-axis direction and the Y-axis direction simultaneously, and thus a trajectory along a corner cannot be traced, but as indicated by a thick line in FIG. 5B, a change in the moving speed can be reduced.

According to the above-explained trajectory and moving speed, when the supply amount of the applying material is set to be constant, the applying material is applied as illustrated in FIG. 5C. That is, a spot clumping can be suppressed, but the supply amount of the applying material increases together with a change in the speed, and thus the applying material becomes thick. According to this structure, also, the applied applying material becomes thick at the start point of the application and the end point thereof like the first conventional example. Hence, although an occurrence of a spot clumping can be suppressed, there is a problem in the quality of the applying object.

### (3) Embodiment of Present Disclosure

According to this embodiment, the motor 22a is controlled based on the moving speed stored in the moving-speed memory 18a. That is, the applicator unit B2 is controlled so as to move between points at a moving speed that can realize a target trajectory. In addition, the supply-amount adjuster 19 calculates an instruction pulse rate to the supplying motor 22b of the applying device B based on the moving speed stored in the moving-speed memory 18a and the supply amounts stored in the supply-amount memory 19a and the pulse supply-amount memory 19b. That is, the supplying motor 22b is controlled so as to keep the supply amount of the applying material per a unit length constant.

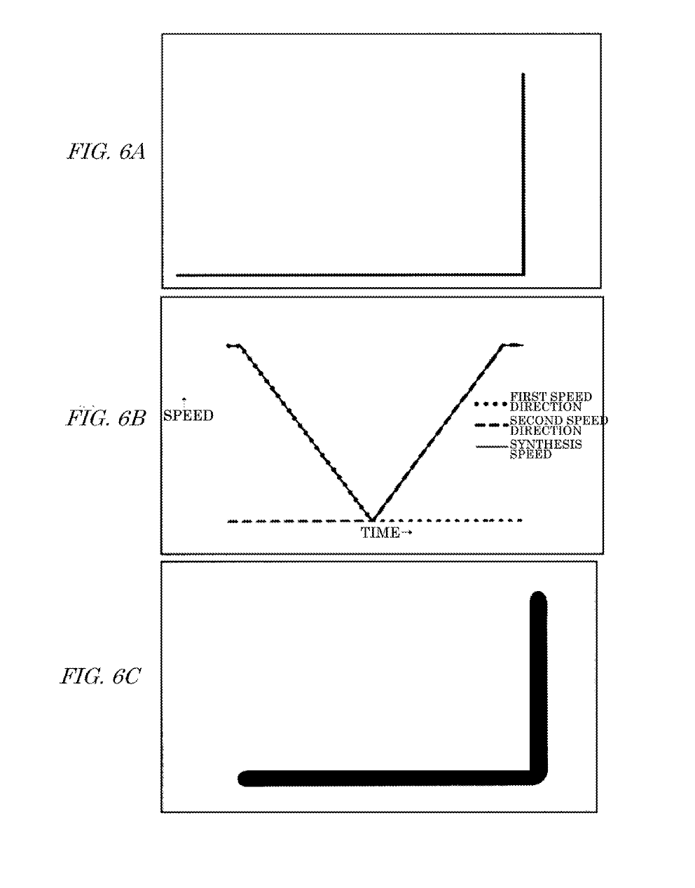

FIGS. 6A to 6C illustrate an example application according to this embodiment. FIG. 6A illustrates a trajectory through which the applicator unit B2 passes on an applying object, FIG. 6B is a graph indicating a moving speed in the X and Y axis directions, and FIG. 6C illustrates how the applying material is applied.

As illustrated in FIG. 6A, the applicator unit B2 has the holder controlled so as to follow a trajectory turning at right angle along the corner of the apply target object. In this case, the moving-speed memory 18a stores a moving speed indicated in the graph of FIG. 6B. That is, for example, the moving speed in the X-axis trajectory (first speed direction in the figure) is gradually decelerated, and after the applicator unit B2 reaches the vertex of the corner, the moving speed in the Y-axis trajectory (second speed direction in the figure) is gradually accelerated. According to this method, the applicator unit B2 is not moved in both of the X-axis direction and the Y-axis direction simultaneously, and a target trajectory at the corner can be precisely realized.

According to the above-explained trajectory and moving speed, when a control is made so as to keep the supply amount of the applying material per a unit length constant, the applying material is applied as illustrated in FIG. 6C. That is, the supply amount of the applying material is appropriately changed in accordance with a change in the speed.

Hence, no spot clumping is caused, and the applying material can be applied with a desired amount.

[1.3 Effects of the Embodiment]

The robot A of this embodiment employing the above-explained structure has the following advantageous effects.

(1) The supply-amount adjuster 19 is provided which calculates an instruction pulse rate to the supplying motor 22b based on the input moving speed of the holder, the supply amount of the applying material by the supplying motor 22b per a pulse, and the supply amount of the applying material per a unit work length, controlling the supply amount of the applying material per a unit length so as to be constant. Hence, a target trajectory can be precisely realized, and an occurrence of a spot clumping of the applying material can be suppressed.

(2) When the moving speed of the holder is a fixed value and is set to be constant throughout the whole trajectory, a teaching work to the robot A can be facilitated. In this case, since the supply amount of the applying material per a unit length is controlled so as to be constant, an occurrence of a spot clumping of the applying material can be prevented.

(3) When the moving speed of the holder is changed in accordance with a trajectory, it is possible to change an instruction pulse rate to the supplying motor 22b as needed. Hence, the movement of the robot A and the applying work by the applying device B can be synchronized with each other. Therefore, a target trajectory can be precisely realized, and an occurrence of a spot clumping of the applying material can be prevented.

When the moving speed is a fixed value, in order to realize a target trajectory, it becomes sometimes necessary to set a slow moving speed. Conversely, when the moving speed is changed in accordance with a trajectory, a restraint to the work speed by the robot can be reduced, enabling a fast-speed applying work, and improving the quality of the applying object.

### 2. Other Embodiments

The present disclosure is not limited to the aforementioned embodiment, and permits various modifications as needed.

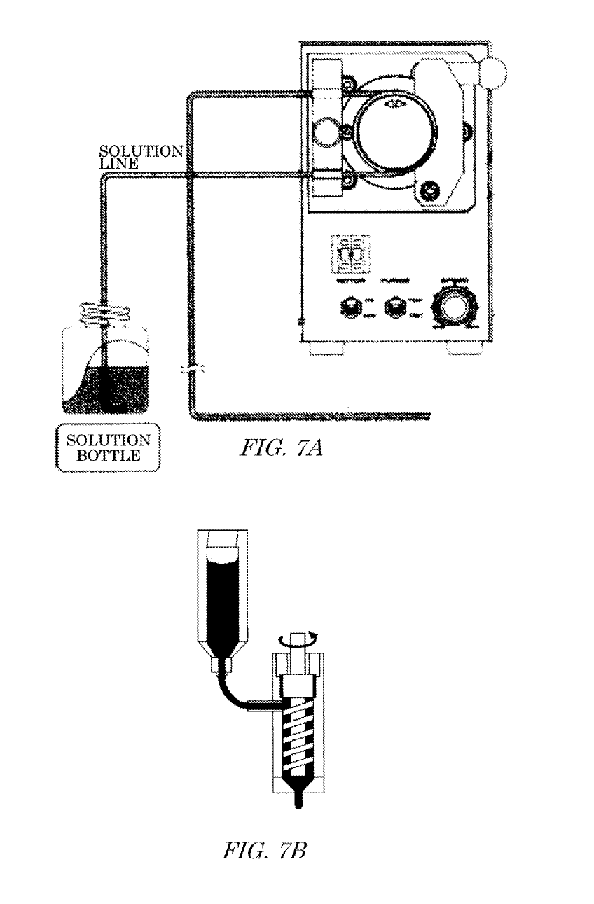

(1) According to the aforementioned embodiment, the explanation was given of an example case in which the applying device B is a solder supplying device that supplies a solder to the applicator unit B2 from the reserve tank B1 by the power of the stepping motor, but the structure of the applying device B is not limited to this case. The same advantageous effects as explained above can be accomplished as long as the applying device B which can precisely control a solution application is connected to the robot A. That is, as illustrated in FIG. 7A, a rotary tubing type applying device controlling, by a motor drive, a supply amount by moving a member that collapses a tube through which an applying material passes is applicable. In addition, as illustrated in FIG. 7B, a screw type applying device controlling a supply amount by a drive of a screw type pump motor is also applicable. Still further, a non-contact dispenser type device precisely controlling a tiny discharge amount per a shot is also applicable.

(2) In the aforementioned embodiment, a structure was employed in which a movement in the X-axis direction is carried out by the slide table A6, but through what component a movement in the X, Y, and Z axis directions is carried out can be modified as needed. That is, the support pole A2 may be provided so as to be movable in the X-axis direction to carry out a movement in the X-axis direction.

(3) The aforementioned control device can be realized by controlling a computer including a CPU through a predetermined program. In this case, the program utilizes physical hardware resources of the computer to realize the above-explained processes. Hence, a method, a program, and a recording medium having stored therein the program for executing the above-explained processes are also embodiments of the present disclosure.

How to set a process range by hardware resources and a process range by software including the program is not limited to any particular way. For example, any one of the respective components may be realized as a circuit that executes the own process.

(4) The embodiments of the present disclosure were explained above, but various omissions, replacements, and modifications can be carried out without departing from the scope of the present disclosure. Such embodiments and modifications thereof are within the scope of the present disclosure, and also within the range of the subject matter as recited in the appended claims and the equivalent range thereto.

What is claimed is:

1. A robot connected with an applying device comprising a reserve tank that reserves an applying material, and an applicator unit that applies the applying material to an applying object, and
supplying the applying material from the reserve tank to the applicator unit by power of a motor,
the robot comprising:
a holder moving the applicator unit relative to the applying object;
a supply-amount adjuster adjusting a supply amount of the applying material by the applying device; and
a moving-speed setter setting a moving speed of the holder,
wherein the supply-amount adjuster comprises a pulse rate calculator calculating an instruction pulse rate to the motor.

2. The robot according to claim 1, wherein the pulse rate calculator calculates the instruction pulse rate to the motor based on the moving speed of the holder, a supply amount of the applying material by the motor per a pulse, and a supply amount of the applying material per a unit work length set in advance.

3. The robot according to claim 1, wherein:
the moving speed setter changes the moving speed of the holder in accordance with a trajectory; and
the pulse rate calculator sequentially calculates the instruction pulse rate to the motor based on the changing moving speed.

4. The robot according to claim 1, wherein the applying device is a solder supplying device or a bond applying device.

5. A method for controlling, through a computer or an electronic circuit, a robot connected with an applying device comprising a reserve tank that reserves an applying material, and an applicator unit that applies the applying material to an applying object, and supplying the applying material from the reserve tank to the applicator unit by power of a motor,
wherein:
the robot comprises a holder moving the applicator unit relative to the applying object;
the computer or the electronic circuit executes:
a supply-amount adjusting step for adjusting a supply amount of the applying material by the applying device; and
a moving-speed setting step for setting a moving speed of the holder; and
the supply-amount adjusting step comprises a step for calculating an instruction pulse rate to the motor.

6. A computer readable non-transitory recording medium having stored therein a control program for a robot connected with an applying device comprising a reserve tank that reserves an applying material, and an applicator unit that applies the applying material to an applying object, and supplying the applying material from the reserve tank to the applicator unit by power of a motor,
wherein:
the robot comprises a holder moving the applicator unit relative to the applying object;
the control program causes a computer or an electronic circuit executes:
a supply-amount adjusting step for adjusting a supply amount of the applying material by the applying device; and
a moving-speed setting step for setting a moving speed of the holder; and
the supply-amount adjusting step comprises a step for calculating an instruction pulse rate to the motor.
